(19) United States
(12) Patent Application Publication
(10) Pub. No.: US 2018/0334904 A1
(43) Pub. Date: Nov. 22, 2018

(54) Optical Interface with Surface Coating

(71) Applicant: Halliburton Energy Services, Inc., Houston, TX (US)

(72) Inventors: William Cecil Pearl Jr., Houston, TX (US); David L. Perkins, The Woodlands, TX (US); James M. Price, The Woodlands, TX (US)

(73) Assignee: Halliburton Energy Services, Inc., Houston, TX (US)

(21) Appl. No.: 15/777,139

(22) PCT Filed: Oct. 10, 2016
(86) PCT No.: PCT/US2016/056236

§ 371 Date: May 17, 2018

(51) Int. Cl. E21B 49/08; G02B 1/18; G02B 1/11; G01V 8/02; G01N 21/55

(52) U.S. Cl. CPC E21B 49/08; G02B 1/18; B29D 11/00298; G01V 8/02; G01N 21/55; G02B 1/11

(57) ABSTRACT

An optical device provided to interrogate a fluid sample. The optical device includes a light source configured to provide an light, an optical interface configured to allow the light to pass through to interact with the fluid sample, and a multi-scale ommatidial array (MO A) applied to the optical interface.

### BACKGROUND

This section is intended to introduce the reader to various aspects of art that may be related to various aspects of the presently described embodiments. Accordingly, it should be understood that these statements are to be read in this light and not as admissions of prior art.

Optical devices and tools can analyze various fluids, for example, crude petroleum, gas, water, and other wellbore fluids in a downhole environment. For instance, an optical device can transmit light from a light source towards a fluid where an optical substrate separates the fluid from various component parts of the optical device. The optical substrate further provides transmissive and reflective properties to reflect the light off of the fluid. The reflected light is analyzed to reveal information related to the physical and chemical properties of the fluid, for example, the presence and proportion of a particular component within the fluid.

### BRIEF DESCRIPTION OF THE DRAWINGS

For a detailed description of the embodiments of the invention, reference will now be made to the accompanying drawings in which:

FIG. 1A is a schematic diagram of an example wireline system for analyzing downhole wellbore fluids in an oilfield environment, in accordance with one or more embodiments;

FIG. 1B is a schematic diagram of an example logging system for analyzing downhole wellbore fluids in an oilfield environment, in accordance with one or more embodiments;

FIG. 1C is a schematic diagram of an example production system for analyzing downhole wellbore fluids in an oilfield environment, in accordance with one or more embodiments;

FIG. 2A is a schematic diagram of an example optical device including an optical interface with a multi-scale ommatidial array (MOA), in accordance with one or more embodiments;

FIG. 2B is a schematic view of an example optical device including an optical interface with a multi-scale ommatidial array (MOA) and a sampling device, in accordance with one or more embodiments; and

FIG. 3 is a schematic diagram of an example process of applying a MOA onto an optical substrate, in accordance with one or more embodiments.

### DETAILED DESCRIPTION

Downhole devices and equipment are often subjected and operationally affected by various downhole fluids including gases, liquids, mixtures thereof, and potentially solids, as well. A downhole optical device may include an optical substrate positioned to separate and to prevent contact between components of the optical device and a downhole fluid. However, when in contact with the fluid, the optical substrate may lose its transparency and/or transmittance qualities when dissolved materials of the fluid settle or adhere on a surface thereof. Further, metal or brazen materials used in the optical device can corrode or deteriorate due to downhole conditions (e.g., pressure, temperature) and/or the chemical composition of the fluid. In embodiments, a surface of the downhole optical device is coated with a micro-structured material to inhibit or eliminate various factors that hinder operability, such as fog, water pooling, and corrosion, among others. Accordingly, the micro-structured material provides or enhances the anti-reflective, hydrophobic, anti-fogging, and even, anti-corrosive properties of the downhole optical device.

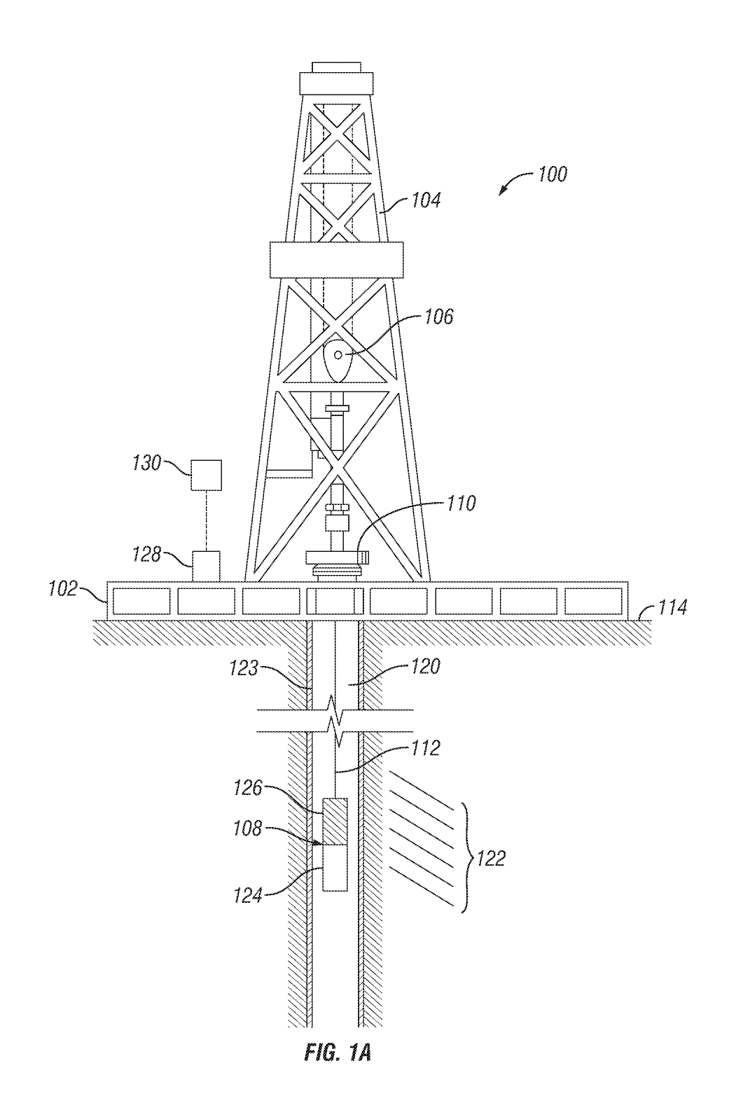

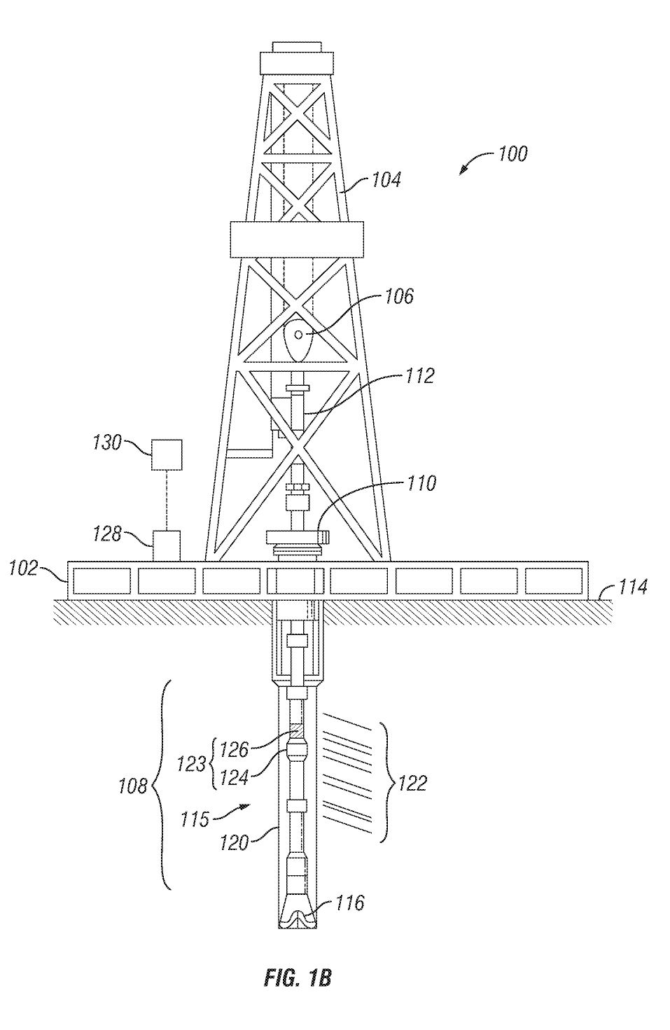

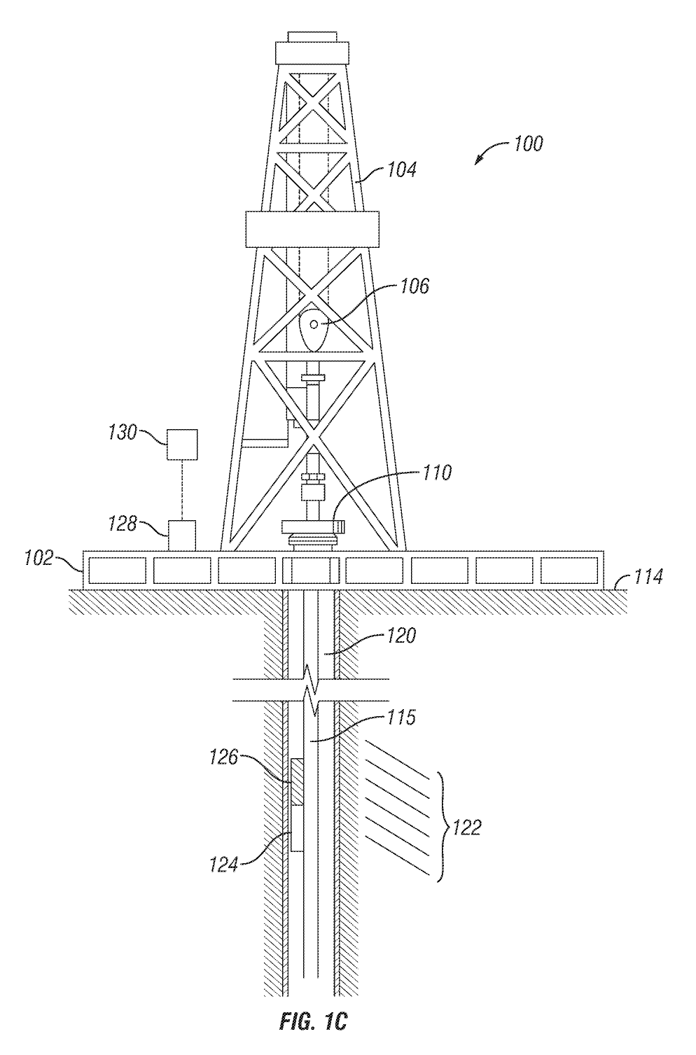

FIG. 1A is a schematic diagram of an example wireline system for analyzing downhole wellbore fluids in an oilfield environment 100, in accordance with one or more embodiments. A platform 102 is equipped with a derrick 104 that supports a hoist 106 for raising and lowering a work tool 108 through a well head 110 of a wellbore 120. In general, the wellbore 120 contains a wellbore fluid, for example, crude petroleum flowing from formations 122, drilling mud, brine, water, chemical treatment fluids, or other substances and combinations thereof. Certain wellbore fluids serve several functions including transporting drilled cuttings from the wellbore, preventing fluid influx, maintaining wellbore stability, and lubricating and cooling the work tool 108 during drilling operations.

The wireline system 112 can provide structural support to raise and lower the work tool 108, for example, using communication cabling (e.g., metal wires, fiber optics) disposed between the work tool 108 and a ground surface 114. The wireline system 112 may include slickline, coiled tubing, tractor, pipe or other conveyance mechanisms. In addition to providing downhole tool support, the wireline system 112 may be used to implement communication between the downhole environment and the ground surface 114. In one or more embodiments, the wireline system 112 may be implemented in other downhole environments. For example, the wireline system 112 may be attached and secured along a length of the work tool 108 or the wireline system 112 may be located within a casing 123 of the wellbore 120. In other cases, the wireline system 112 may be located within production tubing, as will be described with respect to FIG. 1C, or other conduits through which fluids flow to and from the formations 122. The mounting of the wireline system 112 to the work tool 108 or within the casing 123 or production tubing provides continuous monitoring and control during production and other downhole operations.

Depending on the implementation, it may be necessary to engage in ancillary operations during drilling and production operations, such as evaluating the production capabilities of the formations 122 or testing of the wellbore fluid. Formation zones related to the formations 122 are often evaluated to produce information related to the vitality and the potential production capacity and commercial exploitation of the wellbore 120. Additionally, testing of the wellbore fluid provides information related to its physical and/or chemical properties that may affect production efforts. Accordingly, it is often beneficial to hydrocarbon optimization to reduce or eliminate any hindrances to retrieving accurate data related to the wellbore 120.

The work tool 108 may be integrated with multiple devices/tools known to those skilled in the art, including measuring devices and analyzing devices to retrieve, analyze and/or generate wellbore-related information. As an example of the embodiments described herein, the work tool 108 includes an optical device 124 configured with various types of technologies and capabilities to generate and log information related to the wellbore fluids. During operations, wellbore temperatures and pressures and abrasive and acidic components, among other wellbore conditions, may affect the functions and properties of the optical device 124. In the embodiments, as will be further discussed, the optical device 124 includes at least one surface enhanced with a multi-scale ommatidial array (MOA) to minimize the influence of such wellbore conditions and/or to enhance the performance of the device 124.

In addition to the optical device 124, other devices and tools of the work tool 108 can include, but are not limited to, rotary steering tools, directional drilling tools, hole-enlargers, or stabilizers. For instance, the information captured by the optical device 124 can be forwarded to a transmitter 126 attached to the work tool 108. The transmitter 126 receives real-time or delayed information and, thereafter transmits the information to a receiver 128 located on the platform 102, for example. The information is transmitted, logged, and analyzed by a computing system 130 located at the platform 102 as shown or located remotely (not shown).

While FIG. 1A is described with respect to certain preferred embodiments during process operations, it is obvious that equivalent alterations and modifications will occur upon the reading and understanding of the specification. For example, the oil field environment 100 can support other operations including drilling, completion, production, and monitoring operations, among others. Additionally, the work tool 108, including the optical device 124, may be operational outside of the oil field and/or downhole environments. For instance, the work tool 108 may be used for analysis in a laboratory environment or with any tool incorporating a window, for example, for spectroscopy analysis.

FIG. 1B is a schematic diagram of an example logging system for analyzing downhole wellbore fluids in an oilfield environment 100, in accordance with one or more embodiments. A platform 102 is equipped with a derrick 104 that supports a hoist 106 for raising and lowering a work string 108 through a well head 110 of a wellbore 120. The hoist 106 suspends a top drive 112 that rotates the work string 108, which includes a bottom-hole assembly (BHA) 115 connected to the work string 108. The BHA 115 provides directional control, for example, to control the trajectory of a drill bit 116, and consequently, the trajectory of a wellbore 120. The BHA 115 can include various downhole devices including the drill bit 116, drill collars, subs such as stabilizers, reamers, shocks, hole-openers, and bit subs. The BHA 115 can also include measuring devices and analyzing devices to retrieve, analyze and/or generate wellbore-related information, among other components, such as a logging-while-drilling (“LWD”) system 123. The LWD system 123 incorporates logging tools into the work string 108 to administer, interpret, and transmit real-time measurements related to formations 122 to a ground surface 114. A type of LWD, Measurement-While-Drilling (“MWD”) refers to information, such as directional and orientation information, used to steer the drill bit 116. While distinctions between MWD and LWD may exist, the terms MWD and LWD may be used interchangeably. For the purposes of the embodiments, the term LWD will be used generically to encompass systems that collect parameter data in a downhole environment.

In one or more embodiments described herein, the LWD system 123 includes an optical device 124 configured with various types of technologies and capabilities to generate and log information related to the wellbore fluids. During operations, wellbore temperatures and pressures and abrasive and acidic components, among other wellbore conditions, may affect the functions and properties of the optical device 124. In the embodiments, as will be further discussed, the optical device 124 includes at least one surface enhanced with a multi-scale ommatidial array (MOA) to minimize the influence of such wellbore conditions and/or to enhance the performance of the device 124.

The information captured and logged by the optical device 124 can be forwarded to a transmitter 126 attached to the work string 108. The transmitter 126 receives real-time or delayed information and, thereafter transmits the information to a receiver 128 located on the platform 102. The transmitted information is analyzed by a computing system 130 located at the platform 102 as shown or located remotely (not shown).

While FIG. 1B is described with respect to certain preferred embodiments during drilling operations, it is obvious that equivalent alterations and modifications will occur upon the reading and understanding of the specification. For example, the oil field environment 100 can support other operations including completion, production, and monitoring operations, among others. For example, FIG. 1C illustrates an example production system for analyzing downhole wellbore fluids in an oilfield environment 100, in accordance with one or more embodiments. A wellbore 120 can include the production system composed of a production string 115 where an optical device 124 configured with various types of technologies and capabilities to generate and log information related to the wellbore fluids is attached to the string 115. The optical device 124 includes at least one surface enhanced with a multi-scale ommatidial array (MOA) to minimize the influence of such wellbore conditions and/or to enhance the performance of the device 124.

The information captured by the optical device 124 can be forwarded to a transmitter 126 also attached to the production string 115. The transmitter 126 receives real-time or delayed information and, thereafter transmits the information to a receiver 128 located on the platform 102. The transmitted information is analyzed by a computing system 130 located at the platform 102 as shown or located remotely (not shown). The mounting of the optical device 124 and the transmitter 126 in the production string 115 provides for permanent installation with continuous monitoring and control during production and injection operations.

The work string 115 and/or the production string 115 of FIGS. 1B and 1C may be operational outside of oil field and/or downhole environments, for example, in a laboratory environment or with any tool incorporating a window, for example, for spectroscopy analysis.

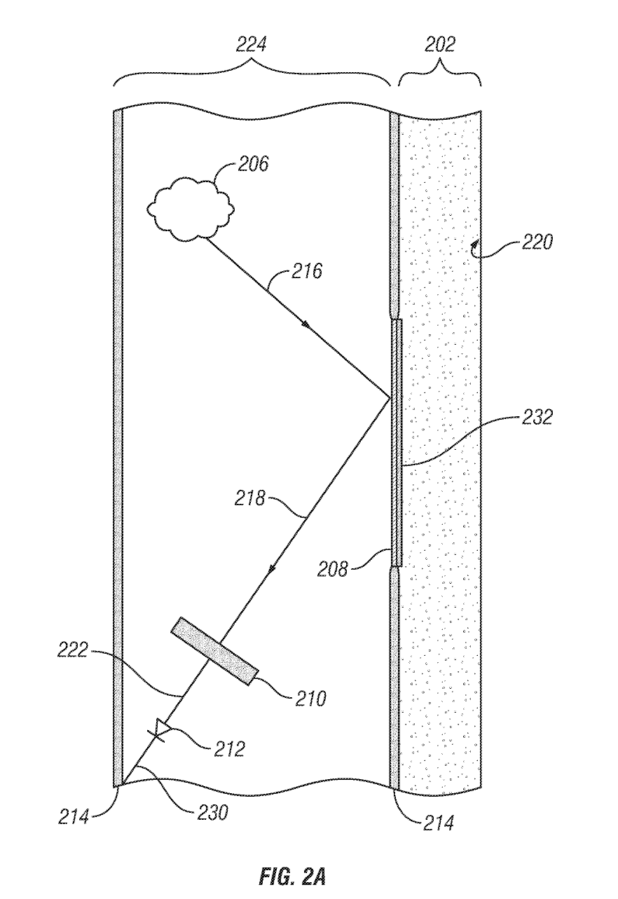

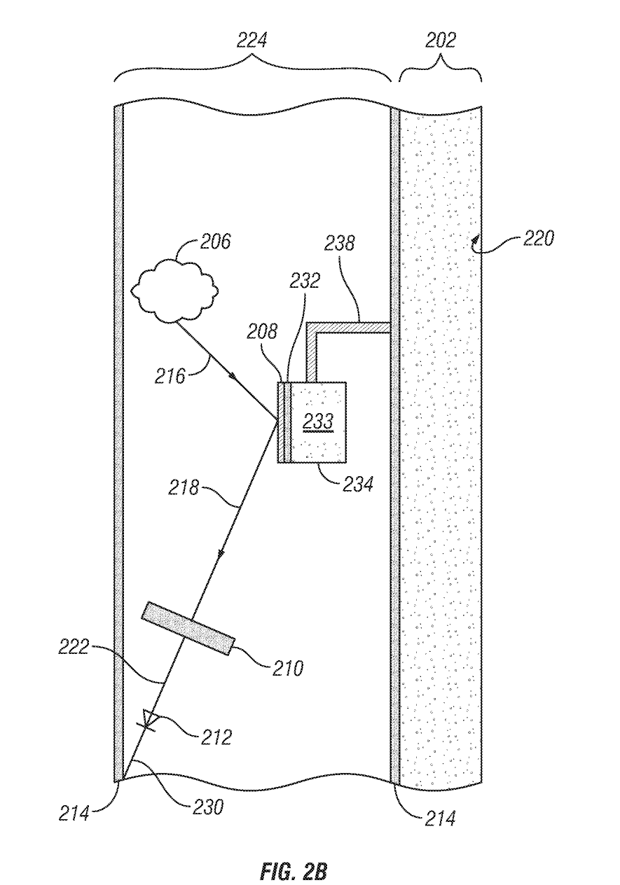

FIG. 2A is a schematic view of an example optical device 224 including an optical interface 208 with a multi-scale ommatidial array (MOA) 232, in accordance with one or more embodiments. The optical device 224 may use integrated computational element (ICE) technology or any other type of optical analysis technology to carry out downhole fluid analysis in a wellbore 220. As an example, an optical element 210 of the optical device 224 uses ICE technology to enable the measurement of various chemical or physical characteristics of a wellbore fluid 202 through the use of regression techniques. When using ICE technology, the optical element 210 selectively weighs a light modified by the wellbore fluid 202 in at least a portion of a wavelength range such that the weightings are related to one or more characteristics of the fluid 202. The optical element 210 includes an optical substrate with multiple stacked dielectric layers (e.g., from about 2 to about 50 layers), each having a different complex refractive index from its adjacent layers. The specific number of layers, N, the optical properties (e.g. real and imaginary components of complex indices of refraction) of the layers, the optical properties of the substrate, and the physical thickness of each of the layers that compose the optical element 210 are selected so that the light processed by the element 210 is related to one or more characteristics of the wellbore fluid 202.

The optical device 224 includes a light source 206, the optical interface 208, the optical element 210, and an optical transducer 212 that are arranged and enclosed with a frame 214. The optical device 224 may be located in proximity to the wellbore fluid 202 to measure the intensity (e.g., spectrum) of light 216 emitted from the light source 206. The light 216 reflects off of the wellbore fluid 202 as a modified light 218 and is processed to obtain information about the fluid 202, for instance, the presence and proportion of a chemical component within the fluid 202. The obtained information may also include, but is not limited to, a concentration of a given substance in the fluid 202, a gas-oil-ratio (GOR), pH value, density, and viscosity.

As shown in FIG. 2A, the optical interface 208 may be located at an interface between the optical device 224 and the wellbore fluid 202 to receive the light 216, for example, with an initial wavelength range of a spectrum, i.e., a minimum wavelength to a maximum wavelength. One skilled in the art will appreciate that the spectrum may extend across a broad spectral range including ultraviolet (UV) light, visible light, and infrared (IR) light. In addition to reflected light, the light 216 interfacing with the optical interface 208 can include a transmitted light, a scatter light, an emitted light, or the like.

The interaction between the light 216 and the wellbore fluid 202 changes the characteristics of the light 216 (e.g., frequency, intensity, polarization) to create the modified light 218. The optical element 210 is configured to receive and process the modified light 218 to determine the wellbore fluid characteristics, for example, chemical, thermal, physical, or optical. To process the modified light 218, the optical element 210 extracts the information related to the multiple characteristics of the wellbore fluid 202 and applies regression techniques to the information to produce a processed light 222. The optical transducer 212 receives and converts the processed light 222 to an optical transducer signal 230 that contains the information related to the multiple characteristics of the wellbore fluid 202. The optical transducer signal 230 can be transmitted to areas external and/or internal to the wellbore 220. For example, and as previously described, the receiver 128 of FIG. 1 may receive and transmit the optical transducer signal 230 to an offsite computing system for data logging or further analysis.

The optical interface 208 is a single substrate or a set of one or more substrates used for its transmissive and/or reflective properties. As a component part of the optical device 224, the optical interface 208 provides a barrier to protect and preserve the integrity of the optical device 224 and its components, such as the optical element 210, from the wellbore fluid 202. The optical interface 208 can include a transparent material, for example, sapphire glass, gorilla glass, silica, quartz, or any other suitable material.

During operations, a surface of the optical interface 208 can come into contact with the various components of the wellbore fluid 202, such as hydrogen sulphide (H₂S), carbon dioxide (CO₂), water, and solid particulates, among other components. When subjected to the various components and/or pressures and temperatures within the environment of the wellbore 220, a surface(s) of the optical interface 208 becomes abrasive, corroded, and/or obstructed and less transparent so as to lose many of its surface properties. For example, some of the fluid components adhere to or pool on the surface of the optical interface 208 to inhibit the transmissive, reflective, and transparent qualities of the interface 208. In this regard, the effectiveness of the optical interface 208 to transmit and reflect the light 216 is hindered.

In one or more embodiments, a multi-scale ommatidial array (MOA) 232 is applied to the surface of the optical interface 208 to reduce reflection, repeal water droplets and other polar molecules, and to resist surface-adhering components found in the wellbore fluid 202. The MOA 232 is positioned as a coating or as a separate film located between the optical interface 208 and the wellbore fluid 202. For example, the MOA 232 is applied to at least one surface of the optical interface 208 and can be applied to the inside, outside, or both the inside and outside surfaces of the optical interface 208.

The MOA 232 is similar in structure to known biological materials such as the eyes of an insect, the wings of a butterfly, and a rose petal, among others. The compound eyes of a moth, for instance, consist of multiple closely-spaced, minute eyes that have a curvilinear design of hexagonally packed microlenses called ommatidium. The ommatidium includes a textured surface with patterns of hexagonally packed, sub-wavelength nanostructures that provide the moth's eyes with varied capabilities such as the ability to reduce reflective light and the ability to repeal and resist the adherence of water.

Accordingly, the application of the MOA 232 to the optical interface 208 provides capabilities similar to the moth's eyes so as to limit or prevent any hindrances to the properties and functions of the optical interface 208 or any other optical tools and downhole equipment. In particular, the MOA 232 provides the optical interface 208 with multi-functional properties such as broadband and omnidirectional anti-reflection, super-hydrophobic, anti-fogging, and anti-corrosive characteristics.

It would be obvious that non-optical devices and tools are also susceptible to the wellbore fluid 202. Downhole components such as seals, screens, and packers, along with rotating and reciprocating parts including shafts, pistons, valves, and pumps can be adversely affected by water, particulates, and contaminants found within the wellbore fluid 202. Thus, the MOA 232 may be applied to a non-optical surface, such as a brazen material of the frame 214, to inhibit or prevent corrosion of non-optical device surfaces that are subjected to wellbore conditions.

FIG. 2B is a schematic view of an example optical device 224 including an optical interface 208 with a multi-scale ommatidial array (MOA) 232 and a sampling device 234, in accordance with one or more embodiments. To optimize the accuracy of the information related to a wellbore fluid 202, the sampling device 234 may receive and store a portion, i.e., a sample 233, of the wellbore fluid 202 via a pipeline 238 connected between the wellbore 220 and the optical device 224. It would be understood that other methods could be used to transport the sample 233 to the sampling device 234. The sampling device 234 houses an optical interface 208 that is coated with a MOA 232 positioned between the optical interface 208 and the sample 233. As previously described, the sample 233 is illuminated by a light 206, which passes through the optical interface 208 to reflect off of the sample 233 to create a modified light 218.

The modified light 218 includes information about multiple characteristics of the wellbore fluid 202. An optical element 210 receives the modified light 218 to determine characteristics of the wellbore fluid 202 using regression techniques or other techniques and to produce a processed light 222. An optical transducer 212 receives and converts the processed light 222 to an optical transducer signal 230 that contains the information related to the multiple characteristics of the wellbore fluid 202.

Configurations of the optical device 224 are not limited to the particular embodiments shown in FIGS. 2A and 2B, but other configurations may be used to interrogate the wellbore fluid 202. For example, to capture reflective measurements, the optical interface 208 may be placed outside of the optical device 224, such as outside of the frame 214. In other examples, the wellbore fluid 202 can flow through a flow-through cell that is mounted within or in close proximity to the wellbore 220 and that monitors the chemical and physical characteristics of the wellbore fluid 202. The MOA 232 can be applied to one or more optical surfaces of the flow-through cell to limit or prevent any hindrances to the properties and functions of the optical surface(s), as previously described with respect to the optical interface 208.

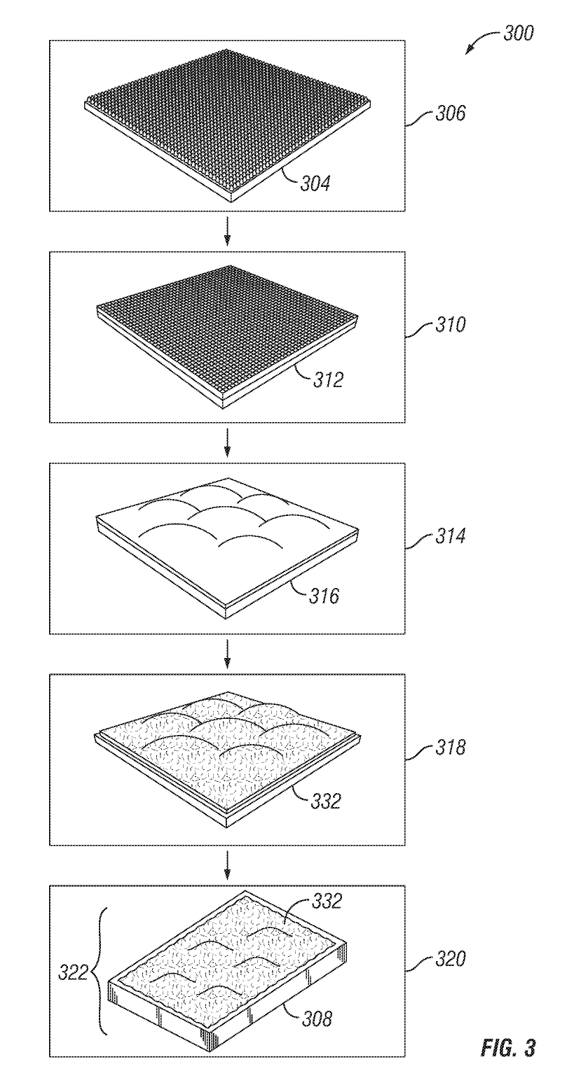

FIG. 3 is a schematic diagram of an example process 300 of applying a MOA 332 onto an optical substrate 308, in accordance with one or more embodiments. One of the characteristics embodied by the MOA 332 includes a multi-functional, multi-scale structure that plays a role in achieving structural and functional integrity when applied or deposited to a surface, optical surface or non-optical surface. As previously explained, the MOA 332 includes multiple microstructures, such as nanostructures, arranged in a hexagonal and square-packed arrangement. As such, the MOA 332 mimics various characteristics of a moth's eye, for example, including anti-reflection, anti-fogging, and super-hydrophobicity capabilities.

In a downhole environment, an optical substrate 308 (e.g., the optical interface 208 of FIG. 2A), may be in direct and/or indirect contact with humidity, high pressures and temperatures, reflected light, and acidic components, among other downhole environmental factors. As shown in FIG. 3, the MOA 332 is applied to the optical substrate 308 to diminish the harsh effects caused by such downhole factors, for example, inhibiting or preventing reduced transparency and deterioration of the surfaces of the optical substrate 308.

The MOA 332 can be fabricated using one or more steps. As discussed herein, an example of a four-step sacrificial layer mediated nanoimprinting (SLAN) technique is used to fabricate the MOA 332. At 306, nanostructures are imprinted on a substrate that may include a thermoplastic polymer (e.g., a polycarbonate film) to form an imprinted substrate 304. The nanostructures are technologically manufactured and arranged in a hexagonal, closely-packed pattern similar to the biological nanostructures found on the eye of a moth.

At 310, the imprinted substrate 304 is coated with a sacrificial layer to form an encapsulated substrate 312. In this regard, the nanostructures are hidden and protected underneath the sacrificial layer. At 314, an imprinting technique is carried out to pattern microlens arrays on the encapsulated substrate 312 to form a patterned substrate 316. Additionally, etching techniques including focused ion-beam etching or reactive ion etching can be used, if an appropriate mask is available, to form the patterned substrate 316. At 318, the patterned substrate 316 is immersed in water to completely dissolve the sacrificial layer and to reveal the MOA 332, which is composed of nanostructures covered with microlenses arrays.

Further, at 320, the fabricated MOA 332 is applied on one or more surfaces of the optical substrate 308 using one or more techniques well-known to one skilled in the art including, but not limited to, imprinting, lithography, and printing. In particular, the fabrication and the application of the MOA 332 onto the optical substrate 308 is employed using known semiconductor lithography methods. For example, next generation optical lithography methods, such as extreme-UV lithography or E-beam lithography, can be used where such techniques provide the resolution needed to create the small features of the nanostructures. Traditional optical lithography techniques that employ phase-shifted masks and/or optical proximity corrections are used to push the resolution limit in an effort to obtain proper array dimensions of the nanostructures. Additionally, self-assembled nanostructured arrays are fabricated using techniques known to those skilled in the art and used to provide the nanostructures.

The optical substrate 308 with the applied MOA 332 forms a MOA-applied optical substrate 322 that can exhibit optimal reflective properties within the ultraviolet (UV) region through the infrared (IR) region while possibly enhancing light sensitivity and reducing reflection losses. In cases studies related to the MOA-applied optical substrate 322, the broadband reduction in reflectance for wavelengths in a range of about 400 nm (nanometers) to about 1000 nm, as opposed to a non-MOA applied optical substrate, was reduced. In particular, the non-MOA applied optical substrate exhibited a minimum reflection of about 8.7% while the MOA-applied optical substrate 322 exhibited a minimum reflectance of about 1.4% up to about 4.8%. With respect to the embodiments described in FIGS. 2A and 2B that relate to a wellbore environment, the application of the MOA 332 reduces the amount of reflected light lost when the optical substrate 308, such as the optical interface 208, is hindered by water droplets, deposit-forming particulates, and other wellbore conditions.

The anti-fogging/hydrophobicity characteristics of the MOA-applied optical substrate 322 produce hydrophobic (i.e., water repellency) and anti-fogging qualities. For example, water droplets may settle and form a fog on the optical substrate 308. The transmittance and/or transparency properties of the optical substrate 308 are reduced where light that passes through the interface 308 is hinder from reflecting off of a fluid, for example, a wellbore fluid. However, the textured surface of the MOA-applied optical substrate 322 exhibits optimal water contact angles so that water droplets on a surface become unstable due to gravitational effects and fail to collect or adhere to that surface. Moreover, the MOA 332 when applied to a non-optical surface, such as a metal surface 214 of FIG. 2A, exhibits anti-corrosive qualities. In particular, the MOA 332 inhibits or prevents deterioration and corrosion of a metal surface in an effort to decrease maintenance cycles and replacement/repair of downhole components.

In addition, to the embodiments described above, many examples of specific combinations are within the scope of the disclosure, some of which are detailed below:

### EXAMPLE 1

An optical device to interrogate a fluid sample, comprising: a light source configured to provide a light, an optical interface configured to allow the light to pass through to interact with the fluid sample, and a multi-scale ommatidial array (MOA) applied to the optical interface.

### EXAMPLE 2

The optical device of Example 1, wherein the MOA is configured to modify at least one property of the optical interface, the at least one property comprising at least one of a hydrophobic property, an anti-corrosive property, a reflection suppression property, and an anti-fogging property.

### EXAMPLE 3

The optical device of Example 1, wherein at least one MOA is located between the optical interface and the fluid sample.

### EXAMPLE 4

The optical device of Example 1, wherein the MOA comprises a coating on a surface of the optical interface.

EXAMPLE 5

The optical device of Example 1, wherein the MOA comprises a film layer adhered to a surface of the optical interface.

### EXAMPLE 6

The optical device of Example 1, wherein the MOA is applied to multiple surfaces of the optical interface.

### EXAMPLE 7

The optical device of Example 1, wherein the MOA comprises a multi-scale texture configured to optimize hydrophobic and/or anti-fogging properties of the optical interface.

### EXAMPLE 8

The optical device of Example 1, wherein the optical interface comprises at least one of a transmissive interface and a reflective interface.

### EXAMPLE 9

The optical device of Example 1, further comprising a frame to house the optical device, wherein the MOA is applied to at least one surface of the frame.

### EXAMPLE 10

The optical device of Example 1, wherein a material of the optical interface is selected from the group consisting of glass, a sapphire-glass material, a quartz material, and a silica material.

### EXAMPLE 11

The optical device of Example 1, wherein the MOA is applied to the optical interface using an imprinting or patterning technique.

### EXAMPLE 12

An optical device for analysis of a fluid, comprising, a light source configured to provide a light, an optical interface configured to allow the light to pass through to interact with the fluid to create a modified light, a multi-scale ommatidial array (MOA) applied to the optical interface, an integrated computational element (ICE) configured to process the modified light to create a processed light, and a detector configured to receive the processed light and to generate an output signal corresponding to a characteristic of the fluid.

### EXAMPLE 13

The optical device of Example 12, wherein the fluid is a downhole fluid.

### EXAMPLE 14

The optical device of Example 12 or 13, wherein a surface of the optical interface is in direct or indirect communication with the fluid.

### EXAMPLE 15

The optical device of Example 12 or 13, wherein at least one MOA is positionable between the optical interface and the fluid.

### EXAMPLE 16

The optical device of Example 12 or 13, further comprising a sampling device configured to receive a sample of the fluid in the wellbore.

### EXAMPLE 17

The optical device of Example 15, wherein the optical interface is located in the sampling device to allow the light to interact with the sample of the fluid received by the sampling device.

### EXAMPLE 18

The optical device of Example 12 or 13, wherein the MOA is configured to modify at least one property of the optical interface, the at least one property comprising at least one of a hydrophobic property, an anti-corrosive property, a reflection suppression property, and an anti-fogging property.

### EXAMPLE 19

A method of analyzing a fluid using an optical device, comprising, directing a light through an optical interface comprising a multi-scale ommatidial array (MOA) to interact with the fluid, receiving a reflected light based on the interaction with the fluid, processing the reflected light to determine a characteristic of the fluid, and generating an output signal corresponding to the characteristic of the fluid.

### EXAMPLE 20

The method of Example 19, wherein the fluid is a downhole fluid.

### EXAMPLE 21

The method of Example 19 or 20, wherein the MOA improves at least one of a hydrophobic property, an anti-corrosive property, a reflection suppression property, or an anti-fogging property of the optical interface.

EXAMPLE 22

The method of Example 19 or 20, wherein the optical interface is located in a sampling device of the optical device.

This discussion is directed to various embodiments of the present disclosure. The drawing figures are not necessarily to scale. Certain features of the embodiments may be shown exaggerated in scale or in somewhat schematic form and some details of conventional elements may not be shown in the interest of clarity and conciseness. Although one or more of these embodiments may be preferred, the embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to suggest that the scope of the disclosure, including the claims, is limited to that embodiment.

Certain terms are used throughout the description and claims to refer to particular features or components. As one skilled in the art will appreciate, different persons may refer to the same feature or component by different names. This document does not intend to distinguish between components or features that differ in name but not function, unless specifically stated. In the discussion and in the claims, the terms “including” and “comprising” are used in an open-ended fashion, and thus should be interpreted to mean “including, but not limited to. . . .” Also, the term “couple” or “couples” is intended to mean either an indirect or direct connection. In addition, the terms “axial” and “axially” generally mean along or parallel to a central axis (e.g., central axis of a body or a port), while the terms “radial” and “radially” generally mean perpendicular to the central axis. The use of “top,” “bottom,” “above,” “below,” and variations of these terms is made for convenience, but does not require any particular orientation of the components.

Reference throughout this specification to “one embodiment,” “an embodiment,” or similar language means that a particular feature, structure, or characteristic described in connection with the embodiment may be included in at least one embodiment of the present disclosure. Thus, appearances of the phrases “in one embodiment,” “in an embodiment,” and similar language throughout this specification may, but do not necessarily, all refer to the same embodiment.

Although the present invention has been described with respect to specific details, it is not intended that such details should be regarded as limitations on the scope of the invention, except to the extent that they are included in the accompanying claims.

1. An optical device to interrogate a fluid sample, comprising:
a light source configured to provide a light;
an optical interface configured to allow the light to pass through to interact with the fluid sample; and
a multi-scale ommatidial array (MOA) applied to the optical interface.

2. The optical device of claim 1, wherein the MOA is configured to modify at least one property of the optical interface, the at least one property comprising at least one of a hydrophobic property, an anti-corrosive property, a reflection suppression property, and an anti-fogging property.

3. The optical device of claim 1, wherein at least one MOA is located between the optical interface and the fluid sample.

4. The optical device of claim 1, wherein the MOA comprises a coating on a surface of the optical interface.

5. The optical device of claim 1, wherein the MOA comprises a film layer adhered to a surface of the optical interface.

6. The optical device of claim 1, wherein the MOA is applied to multiple surfaces of the optical interface.

7. The optical device of claim 1, wherein the MOA comprises a multi-scale texture configured to optimize hydrophobic and/or anti-fogging properties of the optical interface.

8. The optical device of claim 1, wherein the optical interface comprises at least one of a transmissive interface and a reflective interface.

9. The optical device of claim 1, further comprising a frame to house the optical device, wherein the MOA is applied to at least one surface of the frame.

10. The optical device of claim 1, wherein a material of the optical interface is selected from the group consisting of glass, a sapphire-glass material, a quartz material, and a silica material.

11. The optical device of claim 1, wherein the MOA is applied to the optical interface using an imprinting or patterning technique.

12. An optical device for analysis of a fluid, comprising:
a light source configured to provide a light;
an optical interface configured to allow the light to pass through to interact with the fluid to create a modified light;
a multi-scale ommatidial array (MOA) applied to the optical interface;
an integrated computational element (ICE) configured to process the modified light to create a processed light; and
a detector configured to receive the processed light and to generate an output signal corresponding to a characteristic of the fluid.

13. The optical device of claim 12, wherein the fluid is a downhole fluid.

14. The optical device of claim 12, wherein a surface of the optical interface is in direct or indirect communication with the fluid.

15. The optical device of claim 12, wherein at least one MOA is positionable between the optical interface and the fluid.

16. The optical device of claim 12, further comprising a sampling device configured to receive a sample of the fluid in the wellbore.

17. The optical device of claim 15, wherein the optical interface is located in the sampling device to allow the light to interact with the sample of the fluid received by the sampling device.

18. The optical device of claim 12, wherein the MOA is configured to modify at least one property of the optical interface, the at least one property comprising at least one of a hydrophobic property, an anti-corrosive property, a reflection suppression property, and an anti-fogging property.

19. A method of analyzing a fluid using an optical device, comprising:
directing a light through an optical interface comprising a multi-scale ommatidial array (MOA) to interact with the fluid;
receiving a reflected light based on the interaction with the fluid;
processing the reflected light to determine a characteristic of the fluid; and
generating an output signal corresponding to the characteristic of the fluid.

20. The method of claim 19, wherein the fluid is a downhole fluid.

21. The method of claim 19, wherein the MOA improves at least one of a hydrophobic property, an anti-corrosive property, a reflection suppression property, or an anti-fogging property of the optical interface.

22. The method of claim 19, wherein the optical interface is located in a sampling device of the optical device.
